(19) United States
(12) Patent Application Publication
(10) Pub. No.: US 2003/0007079 A1
(43) Pub. Date: Jan. 9, 2003

(54) Electronic personal viewing device

(76) Inventor: Kerry Pauline Sisselman, Hollywood, FL (US)

Correspondence Address: Kerry P. Sisselman, Apt. #806, 2101 S. Ocean Drive, Hollywood, FL, 33019, US

(21) Appl. No.: 10/166,294

(22) Filed: Jun. 10, 2002

Related U.S. Application Data
(60) Provisional application No. 60/297,181, filed on Jun. 8, 2001.

(51) Int. Cl. H04N 5/225

(52) U.S. Cl. 348/231.99; 348/240.1

(57) ABSTRACT

A personal hand-held video device that permits the user to view a scene in real time and then manipulate the scene as desired for replay is provided. A memory sequencing scheme permits the viewer to manipulate automatically stored live action video while continuously storing further live action.

### CROSS REFERENCE TO RELATED APPLICATIONS

The present application is related to and claims the benefit of U.S. Provisional Application Serial No. 60/297,181 filed on Jun. 8, 2001 and entitled ELECTRONIC PERSONAL VIEWING DEVICE.

### BACKGROUND OF THE INVENTION

1. Field of the Invention

The present inventions pertain to a hand-held personal video appliance. More particularly, the present inventions relate to a personal hand-held video device that permits the user to view a scene in real time and then manipulate the scene as desired for replay.

2. Description of the Prior Art

Presently in the prior art there exist devices that permit a user to view real-time events, such as sporting events and record or manipulate the scene. For example, U.S. Pat. No. 4,571,628 to Thornton discloses a portable video viewing assembly wherein an adjustable object lens assembly observes the predetermined field of viewing and additional processing assemblies convert the resulting visual image into electrical video signals which are transferred to a remotely located video recorder which in turn transfers the process signal back to a liquid crystal display specifically dimensioned for mounting within the portable housing along independent lines of sight of the viewing assembly. Remote control means may serve to operate the video recorder so as to accomplish selective and substantially concurrent playback of the previously recorded field of vision selectively observed by the object lens assembly wherein such replay may be reviewed on the liquid crystal display structure within the housing.

U.S. Pat. No. 6,088,053 to Hammack et al. discloses digital record and replay binoculars. The hand-held unit includes conventional binoculars combined with a miniature digital video camera. A display, preferably a liquid crystal display (LCD), is mounted on top of the binoculars. The hand-held unit is designed to permit simultaneous three dimensional viewing of an object through the binoculars and recording of the visual image of the object by the digital video camera. The recorded image may then be viewed on the LCD. If the processing system receives a “record” control signal from the record button 30 the processing system delivers recorded images to memory (a video cache RAM or a PC card) for storage. If a “playback” control signal is delivered by the forward/play button to the processing system, the processing system retrieves images from the memory (the video cache RAM or the PC card) and sends the images to the display (the LCD).

With the above inventions, the viewer must decide in advance of the action when to record and must affirmatively press the record button. However, in live action events, it is often impossible to predict in advance when to record for replay. Further, the invention of the '053 patent provides the replay on a screen located external to and above the binocular elements, thus requiring the user to switch between the binocular elements and the screen to view a replay. In doing so, the user neither views, nor continues to record the live action.

What is needed is a personal viewing device that permits automatic recording of a live event and instantaneous replay and/or further manipulation of the video without the viewer missing significant further live action.

This object, and others, is satisfied by Applicant's present inventions disclosed herebelow.

### SUMMARY OF THE INVENTION

The present inventions are directed towards an automatic viewing and recording device which is specifically dimensioned and configured to be hand-held and used in the same manner as binoculars.

One embodiment of the present inventions relates to a personal viewing device using a memory sequencing scheme that permits the viewer to replay automatically stored live action video.

Related objects and advantages of the present invention will be apparent from the following description.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a front perspective view of a personal viewing device in accordance with one embodiment of the present inventions.

FIG. 2A is a right side perspective view of the personal viewing device of FIG. 1.

FIG. 2B is a left side perspective view of the personal viewing device of FIG. 1.

FIG. 3A is a top perspective view of the personal viewing device of FIG. 1.

FIG. 3B is a bottom perspective view of the personal viewing device of FIG. 1.

FIG. 4 is a back perspective view of a personal viewing device of FIG. 1.

FIG. 5 is a block diagram of a personal viewing device in accordance with one embodiment of the present inventions.

FIG. 6 is a flow diagram of the write pattern to memory under a first circumstance of one embodiment of the present inventions.

FIG.7 is a flow diagram of the write pattern to memory under a second circumstance of one embodiment of the present inventions.

FIG. 8 is a flow chart illustrating the operation of one embodiment of the present inventions.

### DESCRIPTION OF THE PREFERRED EMBODIMENTS

For the purposes of promoting an understanding of the principles of the inventions, reference will now be made to the embodiments illustrated in the drawings and specific language will be used to describe the same. It will nevertheless be understood that no limitation of the scope of the inventions is thereby intended, such alterations and further modifications of the principles of the inventions as illustrated therein being contemplated as would normally occur to one skilled in the art to which the inventions relate.

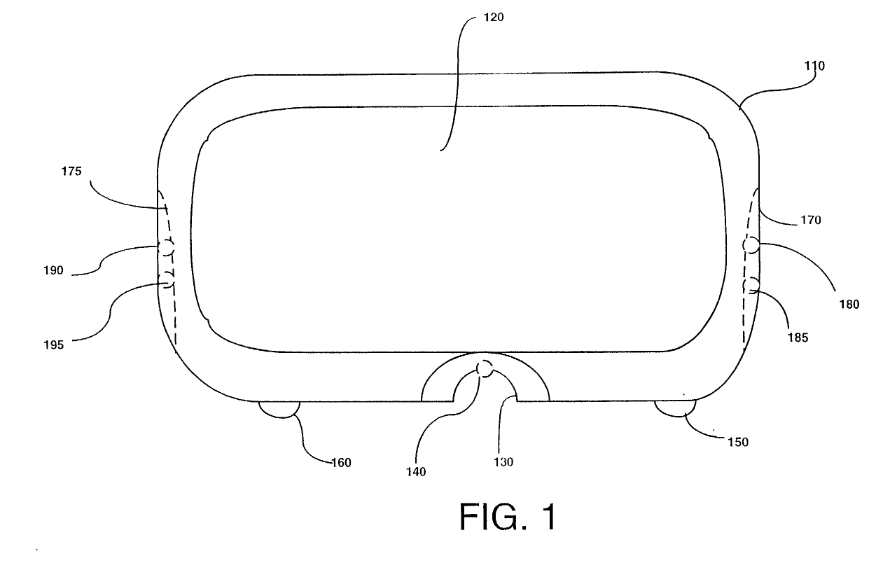

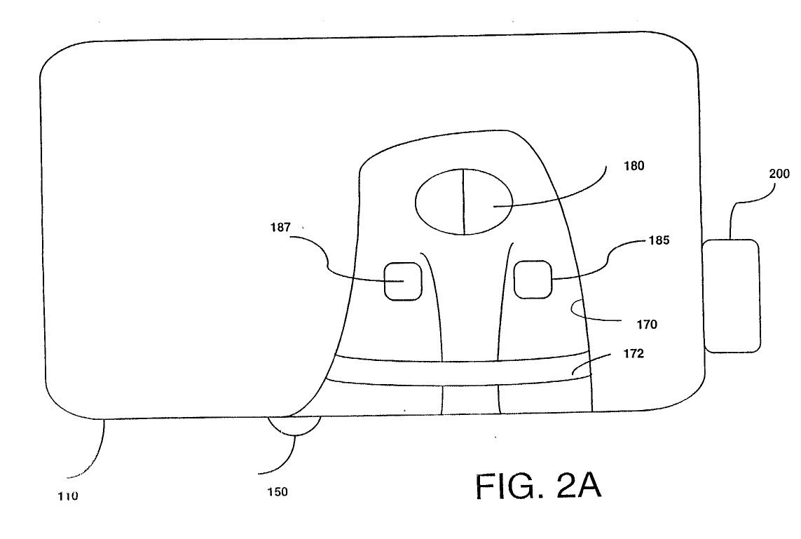

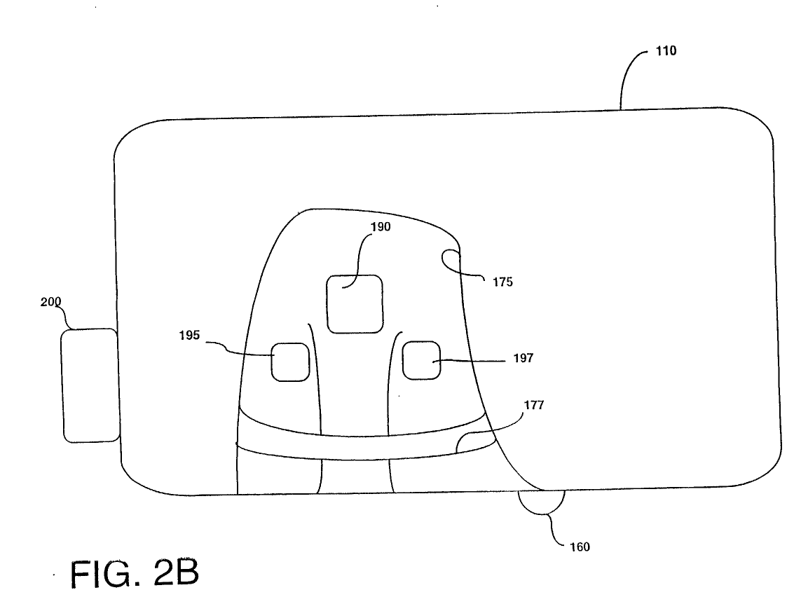

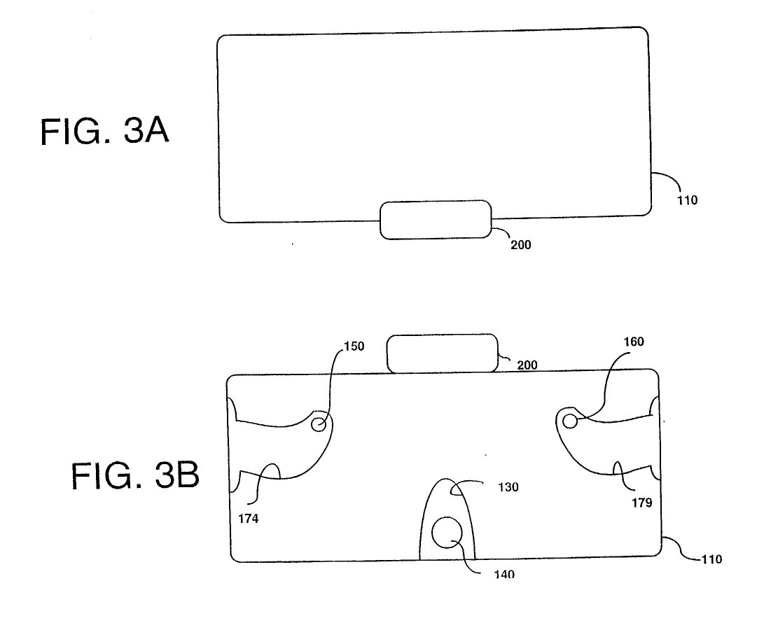

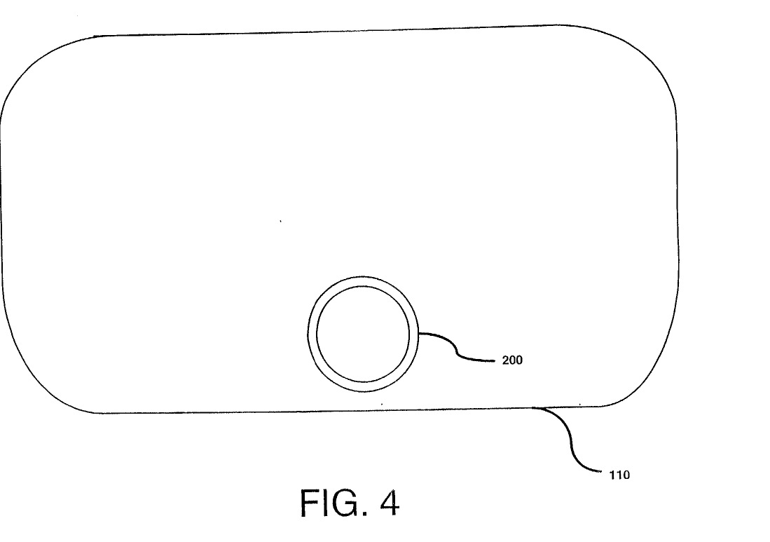

Referring now to FIGS. 1-4, there is shown a personal viewing device in accordance with one embodiment of the present inventions. More specifically, FIG. 1 shows a hand-held personal viewing device 100 including an outer housing 110 and a viewing portion 120. The viewing portion or display 120 includes a television type device, such as an LCD display. Preferably, display 120 is a color LCD display of between four and six inches in length and two to four inches wide. The housing 110 may be formed of plastic or other materials and, if desired, may be molded to ergonomically fit the hands.

Additionally, the housing includes a nose portion 130 to rest against the nose of a viewer to bring the display 120 to eye level. Optionally, the nose portion 130 may include a switch 140 for powering the personal viewing device while it is in contact with the nose. The switch 140 may be a simple pressure switch, a phototransistor, or the like. Alternatively, a traditional on/off switch may be provided to power the device and/or to override the switch 140.

Referring to FIGS. 1-4, control buttons 150, 160, 180, 185, 187, 190, 195 and 197 are used to control the personal viewing device and, if desired, may be set into ergonomic channels 170, 174, 175 and 179 of the housing 110. Ergonomic channels 170, 174, 175 and 179 are adapted to fit an average sized hand and thumb. Straps 172 and 177 are further included to keep the hand in contact with the personal viewing device housing and in close proximity to the control buttons.

Although the control buttons may be placed in any desired order on the unit, for purposes of example, particular control buttons will be described as having particular functions in the present embodiment. For example, in the present embodiment, control button 180 is a rocker switch used to control the physical zoom of the lens 200. Control button 190 controls replay of video, as will be described herein. Control buttons 185, 187, 195 and 197 control the pause, cue, fast forward and slow motion features of the unit, respectively. Control buttons 150 and 160 control the continue and real-time features of the unit, respectively. Each control feature of the unit will be described more fully herein in connection with the selective storing scheme of the present inventions.

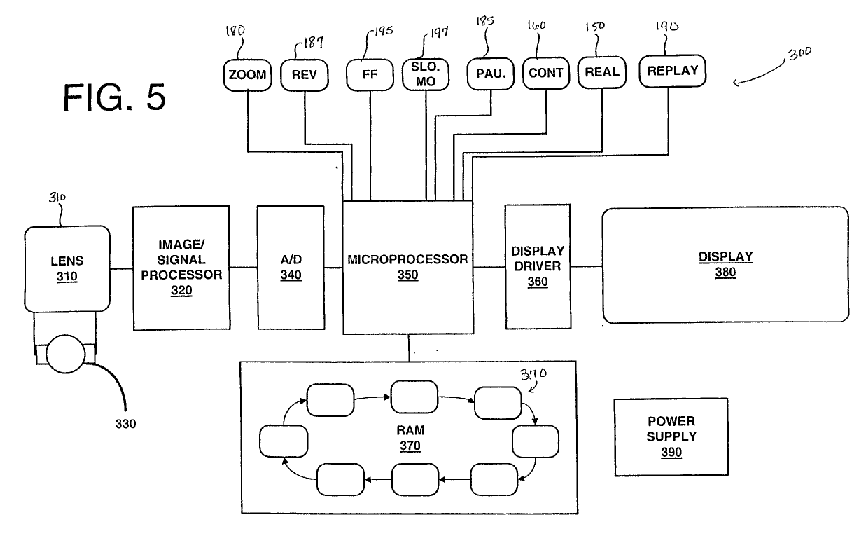

Referring now to FIG. 5 there is shown a block diagram of one particular embodiment of a personal viewing device in accordance with the present inventions. The personal viewing device 300 includes a lens 310 to focus light onto the image/signal processor section 320 of the device 300. Lens 310 may have associated therewith an auto-focus device (not shown) as do camcorders. Such an auto-focus device may include an infrared beam that bounces off objects in the center of the frame and comes back to a sensor on the personal viewing device, in order to calculate the distance to the object and a motor (not shown) that moves the lens, focusing it on objects at this distance. The lens 310 of the personal viewing device 300 includes an optical zoom lens to change the focal length of the lens to move from one magnification to a closer magnification. This permits the user to view the live event at a greater magnification, as though through binoculars or a telescope. Motor 330 adjusts the zoom lens in response to actuation of the zoom control button 180. In addition to the physical zoom, the personal viewing device may additionally include a digital zoom included as part of the image/signal processor 320. Image/signal processor 320 may include a charge-coupled device (CCD) sensor to detect the video image. Such a CCD sensor may include a beam splitter or Bayer filter to extrapolate the color designations of the image, as desired. The signal processor captures a frame of video from the CCD and records it as two fields. For every field of video the CCD transfers all the photosite charges to a second layer of sensor, which then transmits the electric charges at each photosite of the CCD, one by one. While the second layer is transmitting the video signal, the first layer has refreshed itself and is capturing another image. In the present invention, an analog to digital converter 340 samples the analog signal and turns the information into bytes of data, which are sent to the microprocessor. If desired, the signal processor portion of image/signal processor 320 and the A/D 340 may be combined into a single integrated circuit, such as the LM98501 10-Bit, 27 MSPS Camera Signal Processor by NATIONAL SEMICONDUCTOR. The digitally sampled video is provided to the microprocessor 350, which writes the video to RAM 370. When the personal viewing device is operating in “real-time” mode, the digital video is additionally provided to the display driver 360, which conditions the video for display on the display 380. The entire device is powered by the power supply 390, which may be a standard rechargeable camcorder battery.

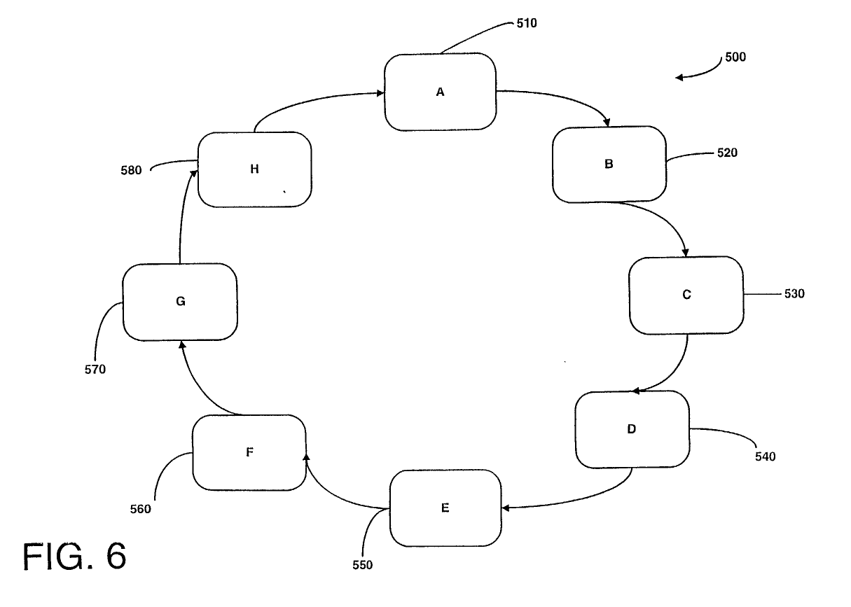

The control buttons operate as follows. The real-time button 150 causes the personal display device 300 to display on display 380, the real-time action as it occurs. During real-time mode, the video is simultaneously and automatically being stored in the RAM 370, as will be described herebelow in connection with FIG. 6. By default, the device operates in real-time mode. If the device is operating in another mode due to action of another control button, the device 300 can be returned to real-time by actuating the real-time control button 150. The zoom control button 180 permits the user in the real-time mode to zoom the focus and magnify a particular location in the device's field of vision, just as with zoom on a camera or camcorder. If desired, a digital zoom may be employed for other display modes, such as during pause, or replay.

The pause control button 185 will freeze the current displayed frame while continuing to store the continuing live action to the RAM 370. Similarly, the slow motion control button 197 will display video from RAM 370 in slow motion, while continuing to store the live action event to other memory locations in the RAM 370. The replay control button 190 will replay memory from previously stored memory locations in the RAM 370, as will be described more fully in connection with FIG. 7. The fast-forward button 195 permits the user to fast forward through video stored in the RAM 370, to catch up with the real-time live video after replay, pause or slow motion modes have been activated. The reverse button 187 lets the video be shown in reverse action. Additional control buttons, such as cue, may be included to permit the memory locations to be sequentially skipped or accessed. The continue button 160 permits the remaining video stored in RAM 370 to continue being displayed after a pause or replay command. The above control modes of the personal display device 300 will be further explained in connection with FIGS. 6 and 7.

Referring now to FIG. 6, there is shown a block diagram exemplary of the memory sequence used in the RAM 370 during “real-time” operation of the personal viewing device 300. In the present particular embodiment, the RAM 370 is sized to receive and store a minute of digital video, in twenty memory segments of three seconds each. This is not meant to be limiting, as more or less RAM may be used, if desired. Similarly, the memory may be broken up into different sized segments, such as 1 second or 5 second units. In the example of FIG. 6, used for explanation only, eight memory segments of 3 seconds each are shown. During real-time mode, the microprocessor 350 of FIG. 5 writes the digital video to the RAM 370 in circular buffer fashion. For example, at all times when the device is in use, the video is being stored in the RAM 370. If desired, RAM 370 may be a dual-port RAM permitting simultaneous reading and writing to the RAM 370. Alternatively, if a fast enough processor is chosen, the video could be written to the RAM 370 and read from the RAM 370 in alternating clock cycles. If desired, a second microprocessor may be included to read stored video from RAM 370 while microprocessor 350 is writing live video to the RAM 370.

The microprocessor 350 addresses the video to a first memory location segment, such as memory location segment A. Once three seconds of video have been stored in segment A, the microprocessor addresses memory segment B, in which the next three seconds of video are stored. Likewise, the remaining memory segments are sequentially addressed and filled by the microprocessor 350. Once all available memory segments have been filled, the microprocessor sequentially addresses and overwrites the video previously stored in memory segments A, B, C, etc. The video is automatically recorded so long as the unit is on. The operator does not need to press record to capture the action.

Referring now to FIGS. 5 and 7, there is shown a block diagram exemplary of the memory sequence once a particular action has been taken on the replay control button 190. During operation of the personal video device 300, the memory locations are initially filled, as described in connection with FIG. 6. At some time in the cycle 500 of FIG. 6, the viewer may actuate the replay button, to see an instantaneous replay of the action just viewed. For example, referring now to FIG. 7, while the microprocessor was writing to memory segment C, the viewer may hit the replay button 190 twice to replay at least the last six seconds of viewed action. Upon receiving a replay control signal, microprocessor 350, would isolate from the memory loop, at least the current memory block being written to by the microprocessor 350. In the present particular embodiment, it is desired that the microprocessor isolate from the memory loop the currently being written memory block (memory segment C of FIG. 7) and one previous memory block for each time the replay button was actuated (memory segments B and A of FIG. 7, if the button was hit twice). At that time, the microprocessor will send to the display driver 360 for conditioning and display, the video stored in the memory segments A, B and C. Simultaneously, the microprocessor 350 continues to write the live video sequentially to the remaining memory segments in the loop. However, in the preferred embodiment, the loop has been broken and once the remaining memory segments are filled and the loop returns to the first isolated memory segment (segment A in the example of FIG. 7) the microprocessor 350 stops writing the action to the video and no further memory segments are overwritten. Alternatively, the loop may be reformed using the non-isolated segments and those memory segments may be sequentially overwritten with the live action.

Referring back to the example of FIG. 7, while in replay mode, the viewer may replay the action in the isolated memory segments 590 using the reverse, fast forward, slow motion and pause buttons. In this way the viewer may go forward and backward through the isolated segments, as desired, while the live action continues to be written to the remaining memory segments 595 (D-H of the example of FIG. 7). Once the viewer has finished reviewing the replay on the isolated segments 590, the viewer may choose to either return to the real-time action, by hitting the real-time control button 150, or may choose to continue viewing the further stored action, so as not to have missed anything. To access the remaining memory segments 595 (D-H of FIG. 7), written to since the replay command was initially received, the viewer may hit the continue button 160. As was possible in replay mode, the viewer may access the further stored video in fast forward or slow motion or pause the video, using the appropriate control buttons.

Once the viewer has exited the isolated memory segments (A-C of the example of FIG. 7) those segments are added back into the loop, and the memory loop is reformed. As such, if the viewer exits the replay mode by hitting real-time, the microprocessor sends the real-time video to the display driver and to the next sequential memory segment of the RAM 370 and proceeds as described in connection with FIG. 6. If the viewer exits the replay mode using the continue command, then the isolated memory is returned to the memory loop and display is started with the next sequential memory segment (D of FIG. 7). The loop of FIG. 6 is reformed, but instead of viewing real-time video, the viewer is shown stored video while the real-time video is saved in the RAM 370. If the fast-forward button is used, the viewer may catch up with the real-time video until the real-time mode is automatically reentered. If the remaining stored video is viewed in slow motion, in the preferred embodiment it is conceivable that the memory loop will run out of storage locations before all of the stored video has been viewed. In such a case the microprocessor may automatically return the viewer to the real-time mode.

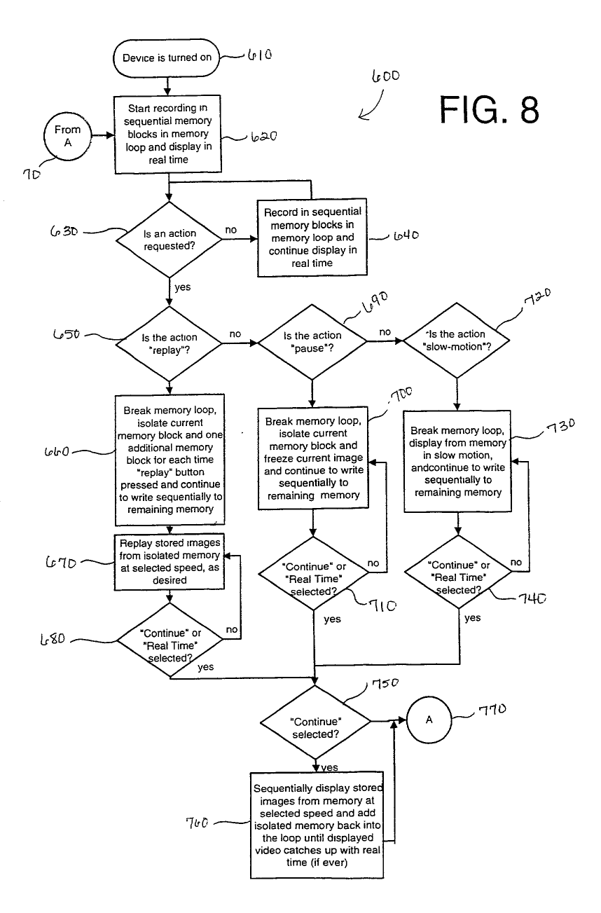

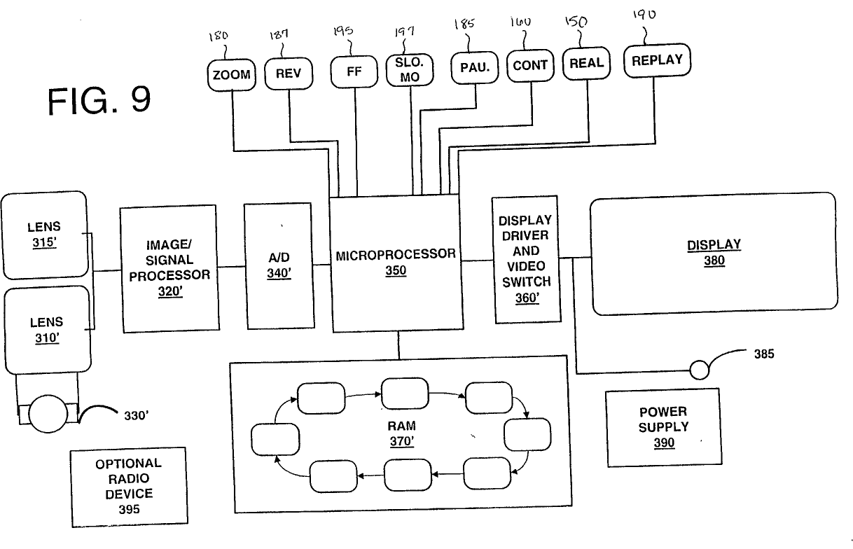

Referring now to FIG. 8 there is shown a block diagram 600 of the operation of one particular embodiment of the present inventions. Initially the device is turned on (step 610) either through the switch (140 of FIG. 1) or a traditional on/off button. Immediately upon turning on, and for the duration the device is on, the received video is recorded in sequential memory blocks in a memory loop, while being displayed in real-time. Step 620. The real-time video is displayed and sequentially stored in accordance with the example of FIG. 6, until a control action (other than zoom) is received by the microprocessor. Steps 630 and 640. Once a control operation is requested the microprocessor takes action according to the control input received. If the received action is “replay”, in the preferred embodiment the microprocessor breaks the memory loop, isolates the current memory block and one additional memory block for each time the “replay” button was pressed. Simultaneously the microprocessor continues to write sequentially to the remaining memory until those memory locations have been filled. Step 660. Additionally, the personal viewing device replays the stored images from the isolated memory, as desired by the viewer. Step 670. The viewer may use the slow motion, fast forward and pause commands to manipulate the stored replayed video. The isolated video segments remain accessible to the viewer in replay mode until either the user selects “continue” or “real-time” modes. Step 680. Alternatively, if the viewer comes to the end of the replay, and no further action is selected for a period of time, such as three seconds, the personal viewing device may default to real-time display of the action.

If the action requested of the microprocessor is “pause”, the microprocessor additionally may break the memory loop, isolate the current memory block with the current image frozen on the display, while continuing to write sequentially to the remaining memory segments until a “continue” or “real-time” command has been selected. Step 700. Similarly, if the action selected is “slow-motion” the microprocessor will break the memory loop, display the video stored in memory in slow motion, and continue to write sequentially to the remaining memory until a “continue” or “real-time” command is received. Step 730.

If after one of the above described other actions has been selected, the microprocessor receives a “continue” command, then the microprocessor sequentially displays the stored images from memory, initially at regular speed, while adding the isolated memory segments back into the memory loop. Step 760. While being played in continue mode, the video may be further manipulated using the fast forward, slow motion and pause keys. If the fast forward button is used, once the stored video catches up with the real-time video, the personal viewing device will return to real-time display.

If after viewing stored video in any of the above described non-real-time modes, the real-time button is pressed, the isolated memory segments are again added back into the memory loop sequence and recording in sequential memory blocks is recommenced with real-time display of video, until another control command is received by the microprocessor. Steps 770 and 620.

The embodiments described in connection with FIGS. 1-8 have been described in a monocular fashion. However, it can be seen that the present inventions can additionally be made having two lenses offset like binocular lenses and two image/signal processors to display in three dimensions. Referring now to FIG. 9, in an alternate embodiment of the present inventions, there is provided a dual lens version of the present inventions, wherein the image/signal processor 320′ processes images from both lenses, which are slightly offset. The display driver 360′ includes a video switch to display the two offset images and provide for a three dimensional, binocular-type display. The device of FIG. 9 additionally includes a video out jack 385 and an optional radio 395. Optional radio 395 permits sports viewers to listen to the event being called on local or special radio stations. Either the video jack 385 or the radio 395 may additionally be included in the embodiment of FIG. 5, if desired.

While the inventions have been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected.

What is claimed:

1. A personal viewing device, comprising:
a portable hand-held housing;
a display contained within said portable hand-held housing, an image capture device;
an image processing portion connected to said image capture device, the output of said image processing portion being a digital representation of an image captured by said image capture device;
a memory for storing said digital representation;
a control section to provide signals representative of said digital representation to said display; and
wherein said memory is configured as a circular buffer.

2. The personal viewing device of claim 1, wherein said control section provides said signals to said display in one of a real time mode and a replay mode.

3. The personal viewing device of claim 2, wherein said digital representation is written into said circular buffer and addressed as relating to a particular memory time segment.

4. The personal viewing device of claim 3, wherein said circular buffer comprises a plurality of said memory time segments

5. The personal viewing device of claim 4, wherein said memory time segments are automatically sequentially overwritten when said control section is in said real time mode, prior to entering said replay mode.

6. The personal viewing device of claim 4, including a user interface in communication with said control section to switch said control section between said real time mode and said replay mode.

7. The personal viewing device of claim 6, wherein said user interface provides a signal to said control section indicating the number of said memory time segments to provide to said display as replay time segments.

8. The personal viewing device of claim 7, wherein said memory time segments comprising said replay time segments are isolated from said circular buffer while said control section is in said replay mode.

9. The personal viewing device of claim 8, wherein said remaining memory time segments not comprising said replay time segments continue to be written while in said replay mode.

10. The personal viewing device of claim 8, wherein said remaining memory time segments not comprising said replay time segments form a new circular buffer and continue to be sequentially written and overwritten while in said replay mode.

11. The personal viewing device of claim 1, wherein said image capture section includes an optical zoom lens.

12. The personal viewing device of claim 2, wherein said control section includes a digital zoom for permitting the image to be magnified during replay mode.

13. The personal viewing device of claim 8, wherein said replay time segments may be further manipulated to be provided to said display in one of fast forward, slow motion and pause modes.

14. A method of providing to a viewer of a personal viewing device with a replay of a previously viewed live image, comprising:
providing a personal viewing device, comprising:
a portable hand-held housing;
a display contained within said portable hand-held housing,
an image capture device;
an image processing portion connected to said image capture device, the output of said image processing portion being a digital representation of an image captured by said image capture device;
a memory for storing said digital representation;
a control section to provide signals representative of said digital representation to said display; and
wherein said memory is configured as a circular buffer;
providing real time captured images to said display when said personal viewing device is on;
writing the captured images to said circular buffer in memory time segments while providing said real time captured images to said display;
receiving a request to replay at least one previously written memory time segment in replay mode;
providing said at least one previously written memory time segment to said display in response to said request.

15. The method of claim 14, wherein said at least one previously written memory time segment is isolated from said circular buffer during said second providing step.
